(19) United States
(12) Patent Application Publication
(10) Pub. No.: US 2012/0172495 A1
(43) Pub. Date: Jul. 5, 2012

(54) UNDERFILL FOR HIGH DENSITY INTERCONNECT FLIP CHIPS

(75) Inventors: Pawel Czubarow, Waltham, MA (US); Osamu Suzuki, Niigata-shi (JP); Toshiyuki Sato, Niigata-shi (JP)

(73) Assignee: NAMICS CORPORATION, Niigata-shi, Niigata (JP)

(21) Appl. No.: 13/395,704

(22) PCT Filed: Sep. 14, 2010
(86) PCT No.: PCT/US10/48706

§ 371 Date: Mar. 13, 2012

Related U.S. Application Data
(60) Provisional application No. 61/242,027, filed on Sep. 14, 2009.

(51) Int. Cl. C09J 163/00; C08K 3/22; C09J 11/04; C08K 5/1515; C08K 3/36; B82Y 30/00

(52) U.S. Cl. 523/456; 523/400; 523/466; 523/457; 106/287.24; 106/287.18; 106/287.14; 977/742; 977/750; 977/752

(57) ABSTRACT

Underfill materials include inorganic fill materials (e.g., functionalized CNT's, organo clay, ZnO) that are functionalized reactive with other organic constituents (e.g., organics with epoxy groups, amine groups, or PMDA). The underfill materials also beneficially include polyhedral oligomeric silsesquioxane and/or dendritic siloxane groups that are functionalized with a reactive group (e.g., glycidyl) that reacts with other components of an epoxy system of the underfill.

### FIELD OF THE INVENTION

The present invention relates generally to an underfill material for use between a semiconductor die and a printed circuit board or package substrate.

### BACKGROUND ART

The electronic industry has sustained decades of continual reduction of the dimensional scale of integrated circuit features. Both the dimensional scale of the transistors in the integrated circuits and the dimensional scale of the electrical connections to the chip have been reduced. The shrinkage of the scale of transistors allows more functionality to be integrated into a single chip. More chip functionality provides for the plethora of functionality found in modern electronic devices such as smartphones that can play music, play videos, capture images and communicate using a variety of wireless protocols.

More functionality also calls for more electrical connections into the chip and into package in which the chip is contained. A semiconductor is typically provided in a package which is sold to OEM customers who mount the package on their printed circuit boards (PCB). The package comprises a substrate on which the chip is mounted. Alternatively, chips without packages are mounted directly on PCBs. A ball grid array (BGA) which can exploit the full area of chip or package provides for a high number of electrical connections into the package. Yet as integrated circuit scales shrink, there is call to shrink the scale of the ball grid array by using smaller balls positioned closer together. When chips are used in portable electronic gadgets such as smartphones it is to be expected that the chip will be subjected to mechanical shocks because such devices are not always treated as sensitive electronic devices and handled gingerly. On the contrary it is to be expected that such devices may be dropped or otherwise abused. Mechanical shocks could cause solder joints in ball grid arrays to fail.

In order provide mechanical reinforcement an underfill material is placed between the chip and the substrate on which the chip is placed. Existing underfill materials comprise an epoxy system including Bisphenol F epoxy resin and a poly-aromatic amine, a silica fill, a silane coupling agent and a fluouro silicone defoamer. The underfill fills in the space between the solder balls of the ball grid array and bonds the chip to the substrate on which it is mounted. Today's highly integrated chips operating at full load can run at relatively high temperature. The underfill can enhance the heat conduction out of the chip, but in the process the underfill becomes heated. When the underfill is heated, especially above the glass transition temperature (Tg) the modulus of elasticity of the underfill drops. When Tg is low the underfill does less to protect BGAs from mechanical shocks.

What is needed is an underfill material that has a higher modulus of elasticity at higher temperatures, e.g., above Tg.

### SUMMARY OF THE INVENTION

According to the present invention, it is to provide an underfill composition comprising the following components (A)-(C):
(A) an epoxy resin,
(B) a curing agent, and
(C) a polyhedral oligomeric silsesquioxane having at least one epoxy group,
   wherein amounts in weight of the above components (A), (B) and (C) satisfy the following relationship:

0.05≦(C)/((A)+(B)+(C))≦0.3.

The underfill composition of the present invention may further contain (D) an inorganic filler.

Certain embodiments of the invention provide additives to an underfill base formulation wherein the additives provides enhanced properties. In certain embodiments the base formulation is an epoxy resin system and an inorgainic fill. In certain embodiments the additives serve to increase the modulus of elasticity that obtains above the glass transition temperature of the underfill so that the underfill provides enhanced bump protection in devices operating at sufficiently high temperature that the underfill is above Tg.

According to certain embodiments an underfill includes an organo clay additive. The organo clay additive may comprise clay with quaternary amine substituents replacing metal ions. The organo clay is preferably 3 roll milled into its exfoliated form of platelets that are thinner than 20 nanometers. The organo clay is suitably Montomorillonite based.

According to certain embodiments an underfill includes a carbon nanotube additive. The carbon nanotube additive is optionally functionalized with a reactive group that is reactive with other constituents of the underfill. For example an aminopyrene reactive group of the nanotube can be reactive with an epoxide group of an epoxy resin component of the underfill.

According to certain embodiments in addition to one or more of the above mentioned additives, the underfill also includes a polyhedral oligomeric silsesquioxane (POSS) additive. The POSS additive is suitably functionalized with a reactive group that reacts with another constituent of the underfill. For example the POSS group can be functionalized with either an amine group or an epoxide group so that it is reactive with at least one constituent of an epoxy resin system that is part of the underfill. The POSS functionalized with epoxide groups has been shown to exhibit superior enhancement of the modulus of the underfill when used at temperatures above Tg.

According to certain embodiments an underfill includes a polysiloxane and/or a dendritic siloxane additive.

According to certain embodiments an organo clay such as a quaternary amine substituted organo clay is combined with a siloxane, or silsesquioxane. The siloxane or silsesquioxane is suitably functionalized with a reactive group, e.g., with an epoxide group.

According certain embodiments an underfill includes Zinc Oxide and pyromellitic dianhydride (PMDA). When subjected to a curing temperature of 150° C. ZnO and PMDA undergo solid state coordination chemical reaction to form a crosslink forming an interconnected network for the purpose of enhancing the modulus of the underfill above Tg.

Whereas existing underfill materials use micro scale particle silica fill, certain embodiments of the present invention use nano scale fill materials (e.g., CNT, organo clay platelets). The nanoscale fill materials increase the modulus above Tg without unduly increasing the viscosity which would be disadvantageous for capillary underfills.

A siloxane that has a plurality, suitably 3 or more reactive groups, acts as a cross-linker of a resin of the underfill. Whereas a crosslinker is normally expected increase the glass transition temperature of a resin system, siloxane used in examples described below does not increase Tg. In certain examples described below although the modulus above Tg is increased, Tg remains largely unchanged, e.g., within 10° C.

Similarly, a CNTs or are functionalized with many reactive groups are also expected to act as crosslinkers but in practice do not adversely effect Tg.

According to embodiments of the invention an underfill that has a glass transition temperature between 90° C. and 135° C. is provided.

According to embodiments of the invention an underfill that has a modulus of elasticity above 0.3 GPa at temperatures above Tg.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a graph including plots of modulus of elasticity versus temperature that were obtained by Dynamic Mechanical Analysis (DMA) testing of a comparative example, a first example and a second example of underfill materials according to embodiments of the invention;

FIG. 2 is a graph including plots of modulus of elasticity versus temperature that were obtained by DMA testing of a comparative example, a third example and a fourth example of underfill materials;

FIG. 3 is a graph including plots of modulus of elasticity versus temperature that were obtained by DMA testing of a comparative example, a fifth example and a sixth example of underfill materials; and

FIG. 4 is a graph including plots of modulus of elasticity versus temperature that were obtained by DMA testing of a comparative example and a seventh example of underfill materials;

FIG. 5 is a graph including plots of modulus of elasticity versus temperature that were obtained by DMA testing of a comparative example an eighth example and a ninth example;

FIG. 6 is a graph including plots of modulus of elasticity versus elasticity versus temperature that were obtained by DMA testing of a comparative example a tenth example and an eleventh example;

FIG. 7 is a graph including plots of modulus of elasticity versus temperature that were obtained by DMA testing of a comparative example and a twelfth example;

FIG. 8 is a graph including plots of modulus of elasticity versus temperature that were obtained by DMA testing of a comparative example and a thirteenth example; and

FIG. 9 is a graph including plots of modulus of elasticity versus temperature that were obtained by DMA testing of a comparative example and a fourteenth example.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

In an embodiment of the present invention, an underfill composition comprises the following components (A)-(C):
(A) an epoxy resin,
(B) a curing agent, and
(C) a polyhedral oligomeric silsesquioxane having at least one epoxy group,
   wherein amounts in a weight ratio of the above components (A), (B) and (C) satisfy the following relationship:

0.05≦(C)/((A)+(B)+(C))≦0.3.

In the underfill composition of the present invention, an amount of the component (C) is defined in a weight ratio to be 0.05 to 0.3 relative to the total amount of the components (A), (B) and (C).

As (A) the epoxy resin to be used in the present invention, it is not specifically limited so long as it has at least two epoxy groups in the molecule and becomes resinous state after curing. (A) The epoxy resin may be either a liquid state at a normal temperature or a solid state at a normal temperature which can be a liquid state by dissolving in a diluent, and preferably a liquid state at a normal temperature. More specifically, there may be mentioned, for example, a bisphenol A type epoxy resin, brominated bisphenol A type epoxy resin, bisphenol F type epoxy resin, biphenyl type epoxy resin, novolac type epoxy resin, alicyclic epoxy resin, naphthalene type epoxy resin, ether series or polyether series epoxy resin, oxirane ring-containing polybutadiene, silicone epoxy copolymer resin, etc.

In particular, as an epoxy resin which is a liquid state at a normal temperature, there may be used a bisphenol A type epoxy resin having a weight average molecular weight (Mw) of about 400 or less; branched polyfunctional bisphenol A type epoxy resin such as p-glycidyloxyphenyldimethyltrisbisphenol A diglycidyl ether; bisphenol F type epoxy resin; phenol novolac type epoxy resin having a weight average molecular weight (Mw) of about 570 or less; alicyclic epoxy resin such as vinyl(3,4-cyclo-hexene)dioxide, (3,4-epoxycyclohexyl)methyl 3,4-epoxycyclohexylcarboxylate, bis(3,4-epoxy-6-methylcyclohexylmethyl)adipate and 2-(3,4-epoxycyclohexyl) 5,1-spiro(3,4-epoxycyclohexyl)-m-dioxane; biphenyl type epoxy resin such as 3,3′,5,5′-tetramethyl-4,4′-diglycidyloxybiphenyl; glycidyl ester type epoxy resin such as diglycidyl hexahydrophthalate, diglycidyl 3-methylhexahydrophthalate and diglycidyl hexahydroterephthalate; glycidyl amine type epoxy resin such as diglycidylaniline, diglycidyltoluidine, triglycidyl-p-aminophenol, tetraglycidyl-m-xylylenediamine and tetraglycidylbis(aminomethyl)cyclohexane; hydantoin type epoxy resin such as 1,3-diglycidyl-5-methyl-5-ethylhydantoin; and naphthalene ring-containing epoxy resin. In addition, an epoxy resin having silicone skeletone such as 1,3-bis(3-glycidoxypropyl)-1,1,3,3-tetramethyldisiloxane may be used. Moreover, there may be exemplified by a diepoxide compound such as (poly)ethylene glycol diglycidyl ether, (poly)propylene glycol diglycidyl ether, butanediol diglycidyl ether and neopentylglycol diglycidyl ether; and a triepoxide compound such as trimethylolpropane triglycidyl ether and glycerin triglycidyl ether.

It is also possible to use a solid state or ultra-high viscosity epoxy resin at a normal temperature in combination with the above-mentioned epoxy resins. Examples of which may include a bisphenol A type epoxy resin, novolac epoxy resin and tetrabromobisphenol A type epoxy resin each of which has a higher molecular weight. These epoxy resins may be used in combination with the epoxy resin which is a liquid state at a normal temperature and/or a diluent to control the viscosity of the mixture. When the solid state or ultra-high viscosity epoxy resin at a normal temperature is used, it is preferably used in combination with an epoxy resin having a low viscosity at a normal temperature such as diepoxide compounds including (poly)ethylene glycol diglycidyl ether, (poly)propylene glycol diglycidyl ether, butanediol diglycidyl ether and neopentylglycoldiglycidyl ether; and a triepoxide compound including trimethylolpropane triglycidyl ether and glycerin triglycidyl ether.

When a diluent is used, there may be used either a non-reactive diluent or a reactive diluent, and a reactive diluent is preferably used. In the present specification, the reactive diluent means a compound having an epoxy group and having a relatively low viscosity at a normal temperature, which may further have other polymerizable functional group(s) than the epoxy group, including an alkenyl group such as vinyl and allyl; unsaturated carboxylic acid residue such as acryloyl and methacryloyl. Examples of such a reactive diluent may be mentioned a monoepoxide compound such as n-butylglycidyl ether, 2-ethylhexyl glycidyl ether, phenyl gylcidyl ether, cresyl glycidyl ether, p-s-butylphenyl glycidyl ether, styrene oxide and a-pinene oxide; other monoepoxide compound having other functional group(s) such as allyl glycidyl ether, glycidyl methacrylate, glycidyl acrylate and 1-vinyl-3,4-epoxycyclohexane; a diepoxide compound such as (poly)ethylene glycol diglycidyl ether, (poly)propylene glycol diglycidyl ether, butanediol diglycidyl ether and neopentyl glycol diglycidyl ether; and a triepoxide compound such as trimethylolpropane triglycidyl ether and glycerin triglycidyl ether.

The epoxy resin may be used singly or in combination of two or more kinds. It is preferred that the epoxy resin itself is a liquid state at a normal temperature. Of these, preferred are a liquid state bisphenol type epoxy, liquid state aminophenol type epoxy, silicone-modified epoxy and naphthalene type epoxy. More preferably mentioned are a liquid state bisphenol A type epoxy resin, liquid state bisphenol F type epoxy resin, p-aminophenol type liquid state epoxy resin and 1,3-bis(3-glycidoxypropyl)tetramethyl disiloxane.

An amount of (A) the epoxy resin in the underfill composition is preferably 5% by weight to 70% by weight, more preferably 7% by weight to 30% by weight based on the total weight of the composition.

As (B) the curing agent to be used in the present invention, it is not specifically limited so long as it is a curing agent of the epoxy resin and a conventionally known compound(s) may be used. There may be mentioned, for example, a phenol resin, acid anhydride series curing agent, aromatic amines and imidazole derivatives. The phenol resin may be mentioned a phenol novolac resin, cresol novolac resin, naphthol-modified phenol resin, dicyclopenadiene-modified phenol resin and p-xylene-modified phenol resin. The acid anhydride may be mentioned methyltetrahydrophthalic anhydride, methylhexahydrophthalic anhydride, alkylated tetrahydrophthalic anhydride, hexahydrophthalic anhydride, methylhymic anhydride, dodecenyl succinic anhydride and methylnadic anhydride. The aromatic amine may be mentioned methylene dianiline, m-phenylene diamine, 4,4′-diaminodiphenylsulfone and 3,3′-diaminodiphenylsulfone. Particularly preferred examples of the curing agent may include a liquid state phenol resin such as an allylic phenol novolac resin, since it provides rather lower Tg.

An amount of (B) the curing agent in the underfill composition is preferably 0.3 to 1.5 equivalents, more preferably 0.6 to 1.0 equivalent based on 1 equivalent of the epoxy group in (A) the epoxy resin.

As (C) the polyhedral oligomeric silsesquioxane to be used in the present invention, it is not particularly limited so long as it has been known as and commercially sold as the polyhedral oligomeric silsesquioxane materials. As the polyhedral oligomeric silsesquioxane, there may be specifically mentioned, for example, commercially available POSS®; registered trademark of Hybrid Plastics, Inc., and the like. Specific examples of the polyhedral oligomeric silsesquioxane may be mentioned a glycidyl polyhedral oligomeric silsesquioxane (POSS) having the following structural formula:

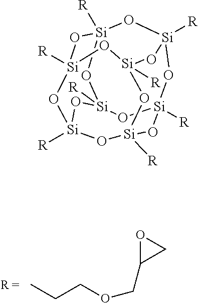

an amine functionalized POSS dendrimer, particularly p-aminobenzenethiol POSS of the following formula:

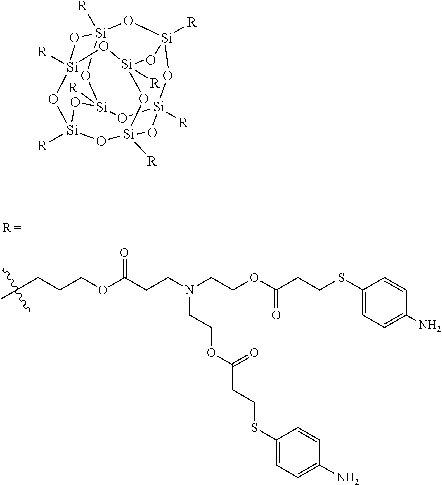

an epoxy cyclohexyl POSS having the following structural formula:

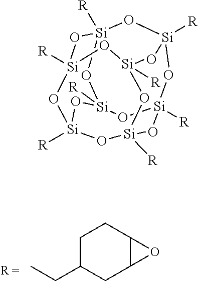

and a triglycidyl cyclohexyl POSS of the following functional formula:

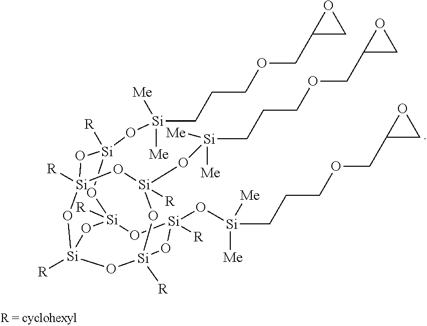

An amount of the polyhedral oligomeric silsesquioxane is 5% by weight to 30% by weight based on the total weight of the composition comprising components (A), (B) and (C) as defined above, preferably 10% by weight to 30% by weight, more preferably 10% by weight to 25% by weight. If an amount of the polyhedral oligomeric silsesquioxane is less than 5% by weight, no effect can be obtained, while if it exceeds 30% by weight, adhesive strength of the hardened composition will be lowered.

As (D) the inorganic filler to be used in the present invention, there may be mentioned, for example, silica such as fumed silica, amorphous silica and crystalline silica; alumina; nitride such as boron nitride, aluminum nitride and silicon nitride; preferably silica, alumina and aluminum nitride. An amount of (D) the inorganic filler is preferably 30% by weight to 80% by weight, more preferably 50% by weight to 70% by weight based on the total weight of the composition. When the amount of the filler is high, the composition can be applied under reduced pressure process. In such a case, the obtained product achieves bump protection more effectively. Higher elastic modulus at high temperature achieves bump protection with a lower filler content.

The underfill composition of the present invention preferably has a Tg after hardening within the range of 55° C. to 115° C. measured by the dynamic mechanical analysis (DMA) method using a dynamic mechanical analyzer EXSTAR DMS6100 manufactured by SII NanoTechnology Inc. The Tg after hardening of the underfill composition can be preferably made 65° C. to 95° C. by adding a Tg modifier mentioned below. When the Tg of the underfill composition of the present invention is measured by the thermal mechanical analysis (TMA) method by using a thermal mechanical analyzer TMA4000S manufactured by MAC Science Co., Ltd., the cured product shows about 10° C. lower than the values measured by the DMA method, i.e., about 45° C. to 105° C.

The underfill composition of the present invention preferably further comprises a Tg modifier to obtain an appropriate Tg after hardening the underfill composition since the hardeners tend to provide rather higher Tg. Such a Tg modifier may be mentioned a reactive diluent including a monoepoxide compound such as n-butylglycidyl ether, 2-ethylhexyl glycidyl ether, phenyl gylcidyl ether, cresyl glycidyl ether, p-s-butylphenyl glycidyl ether, styrene oxide and a-pinene oxide; other monoepoxide compound having other functional group(s) such as allyl glycidyl ether, glycidyl methacrylate, glycidyl acrylate and 1-vinyl-3,4-epoxycyclohexane; a diepoxide compound such as (poly)ethylene glycol diglycidyl ether, (poly)propylene glycol diglycidyl ether, butanediol diglycidyl ether and neopentyl glycol diglycidyl ether; and a triepoxide compound such as trimethylolpropane triglycidyl ether and glycerin triglycidyl ether; etc., preferably polypropylene glycol diglycidyl ether, etc.

The underfill composition of the present invention may further contain other optional ingredients such as a solvent, a flux, a defoamer, a coupling agent, a flame retardant, a curing accelerator, a liquid state or granular state elastomer, a surfactant, etc., which are materials conventionally known in this field of the art. The solvent may include an aliphatic hydrocarbon solvent, an aromatic hydrocarbon solvent, a halogenated aliphatic hydrocarbon solvent, a halogenated hydrocarbon solvent, an alcohol, an ether, an ester, etc. The flux may include an organic acid such as abietic acid, malic acid, benzoic acid, phthalic acid, etc., and a hydrazide such as adipic dihydrazide, sebacic dihydrazide, dodecane dihydrazide, etc. The defoamer may include an acrylic series, silicone series and fluorosilicone series defoamers. The coupling agent may include a silane coupling agent such as 3-glycidoxypropyl trimethoxysilane, 3-glycidoxypropyl(methyl)dimethoxysilane, 2-(2,3-epoxycyclohexypethyl trimethoxysilane, 3-methacryloxypropyl trimethoxysilane, 3-aminopropyltriethoxysilane and 3-(2-aminoethyl)aminopropyltrimethoxysilane. The curing accelerator may include an amine series curing accelerator such as an imidazole compound (2-ethylimidazole, 2-undecylimidazole, 2-heptadecylimidazole, 2-ethyl-4-methylimidazole, 2-phenylimidazole, 2-phenyl-4-methylimidazole, etc.); a triazine compound (2,4-diamino-6-[2′-methylimidazolyl-(1′)]ethyl-s-triazine); a tertiary amine compound (1,8-azabicyclo[5.4.0]undecen-7 (DBU), benzyldimethylamine, triethanolamine, etc.); and a phosphorus series curing accelerator such as triphenylphosphine, tributylphosphine, tri(p-methylphenyl)phosphine, tri(nonylphenyl)phosphine, etc., each of which may be an adduct type adducted by an epoxy resin, etc., or may be a microcapsule type. The elastomer may include a butadiene series rubber such as polybutadiene rubber, styrene-butadiene rubber, acrylonitrile-butadiene rubber, hydrogenated acrylonitrile-butadiene rubber; a polyisoprene rubber; an ethylene-propylene series rubber such as an ethylene-propylene-diene copolymer, ethylene-propylene copolymer, etc.; a chloroprene rubber; a butyl rubber; a polynorbornene rubber; a silicone rubber; a polar group-containing rubber such as ethylene-acryl rubber, acryl rubber, propylene oxide rubber, urethane rubber, etc.; a fluorinated rubber such as hexafluoropropylene-vinylidene fluoride copolymer, tetrafluoroethylene-propylene copolymer, etc. The surfactant may include an anionic surfactant, a cationic surfactant, a nonionic surfactant and an amphoteric surfactant, and preferably a nonionic surfactant such as a polyoxyalkylene chain-containing nonionic surfactant, a siloxane-containing nonionic surfactant, an ester type nonionic surfactant; a nitrogen-containing type nonionic surfactant, and a fluorinated type nonionic surfactant.

The underfill material of the present invention can be used as a capillary flow underfill, apply under reduced pressure underfill, pre-applied underfill and wafer level underfill.

An underfill material of the present invention may comprise:
a resin functionalized with at least a first reactive group;
a nano filler material functionalized with at least a second reactive group
that is reactive with the first reactive group of the resin.
In the underfill material of the present invention, the resin functionalized with at least the first reactive group is a siloxane functionalized with a reactive glycidyl group, and the siloxane functionalized with the reactive glycidyl group is preferably polyhedral oligomeric silsesquioxane functionalized with the glycidyl group, and the siloxane functionalized with the reactive glycidyl group is more preferably tris(glycidoxypropyldimethylsiloxy)phenylsilane. The first reactive group of the functionalized resin is preferably an epoxy group.

In the present invention, the nano filler material is preferably carbon nanotubes which may be functionalized by an amine such as aminopyrene. The carbon nanotubes preferably have an average length of less than 5 microns and are single walled carbon nanotubes or multi walled carbon nanotubes. The carbon nanotubes are preferably bamboo carbon nanotubes, and more preferably single wall carbon nanotubes having average length of less than 5 microns and are functionalized with aminopyrene.

The underfill material of the present invention may further comprises at least one of silica, a silane coupling agent; bisphenol F epoxy resin; and a fluoro silicone defoamer. An underfill prepared by the underfill material of the present invention preferably has a glass transition temperature within a range of about 90° C. to about 135° C., and a Young's modulus above Tg greater than 0.3 GPa.

The filler material of the present invention may further comprises a functionalized organo clay. The functionalized organo clay is preferably in the form of platelets having a thickness dimension that is less than 20 nanometers. The inorganic filler functionalized organo clay may be Montomorillonite functionalized with a quaternary amine. Such a filler material may further contain silica and a silane coupling agent; a polyaromatic amine; bisphenol F epoxy; a fluoro silicone defoamer; and/or a polyhedral oligomeric silsesquioxane. Of these, the polyhedral oligomeric silsesquioxane preferably has at least one epoxy groups such as glycidyl polyhedral oligomeric silsesquioxane; triglycidyl cyclohexyl polyhedral oligomeric silsesquioxane; and epoxy cyclohexyl polyhedral oligomeric silsesquioxane. The filler material containing the above-mentioned additional component(s) may further comprise a branched chain siloxane. The branched chain silioxane may be functionalized with a reactive coupling group. As the reactive coupling group, there may be mentioned an epoxide group.

In another embodiment of the present invention, the underfill material may comprise pyromellitic dianhydride and a metal oxide. As the metal oxide, there may be mentioned zinc oxide. The underfill material may further comprise a glycidyl polyhedral oligomeric silsesquioxane. The filler material containing the above-mentioned additional component(s) may further comprise silica and a silane coupling agent; bisphenol F epoxy; and a fluoro silicone defoamer.

In a further embodiment of the present invention, an underfill comprises:
an epoxy resin; and
an additive which increase a modulus of elasticity above a glass transition temperature of the epoxy resin without substantially altering the glass transition temperature of the epoxy resin.
In this embodiment, the glass transition temperature of the underfill may be altered by the additive by less than 10° C. As such an additive, there may be mentioned glycidyl siloxane.

### EXAMPLES

Certain embodiments included a base formulation to which additives were added. While certain ingredients were used in the several examples described below, the invention should not be construed as limited to a particular base formulation. The base formulation used in several examples described below included an epoxy system including Bisphenol F epoxy resin and a polyaromatic amine, a silica fill, a silane coupling agent and a fluoro silicone defoamer. A Comparative Example below explains the procedure for preparing a particular base formulation.

### COMPARATIVE EXAMPLE

23.00 grams of Bisphenol F epoxy resin were obtained;

10.00 grams of polyaromatic amine resin were obtained;

65.00 grams of fused silica was obtained;

0.50 grams of silane coupling agent was obtained

0.005 grams of fluoro silicone defoamer was obtained.

The above ingredients were thoroughly mixed manually for about an hour in a plastic beaker. Next the mixture was milled using a three roll mill three times. For the first pass through the three roll mill the widest roller gap (about 75 microns) was used. The gap was reduced (to about 50 microns) for the second pass through the three roll mill and for the last pass through the three roll mill the narrowest gap (about 25 microns) was used. Next the mixture was placed under vacuum and degassed for ½ hour in order to remove entrapped air. In all cases the curing temperature for the underfill was 2 hours at 165 C.

A first exemplary embodiment of the invention is given below.

### Example 1

Between 1-3% by weight of a quaternary amine substituted clay were added to the composition described in the above Comparative Example prior to the step of mixing. The percentage of clay is relative to the weight of entire formulation. The quaternary amine clay is a product disclosed in U.S. Pat. No. 6,399,690 and sold commercially under the product designation 1.22E, by Nanocor of Hoffman Estates, Illinois. The clay is added together with the other fillers and everything is then milled using the 3 roll mill. During the milling process the clay exfoliates to single platelets. In effect this results in clay platelets functionalized with quaternary amines on the surface. These surface bound quaternary platelet groups are available for reaction with other reactive groups, e.g., epoxy groups of the base formulation (Comparative Example).

### Example 2

In addition to the constituents of the comparative example,

1% of the same quaternary amine substituted clay that was used in example 1; and

10% of a glycido functionalized branched siloxane, tris(glycidoxypropyldimethylsiloxy)-phenylsilane having the chemical structure shown below were added to the mixture prior to 3 roll milling.

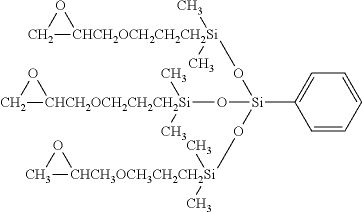

The percentage of branched siloxane is given in terms of epoxy equivalents.

There are certain important properties of candidate capillary underfill materials that can be tested. One such property is the modulus of elasticity which is measured as a function of temperature. The modulus of elasticity can be tested by dynamical mechanical analysis (DMA). DMA provides a plot of modulus of elasticity versus temperature. From such plots it is also possible to identify the glass transition temperature. In order to make samples for DMA the compositions prepared as described in the examples described herein are placed between two glass slides spaced 2 mm apart. This “sandwich” like assembly was then cured at 165° C. for 2 hours. Subsequently the slab of cured epoxy was removed from between the glass plates and was cut into rectangular pieces sized 10 mm×50 mm×2 mm. The rectangular pieces were then placed into the DMA jig and tested from room temp. to 250° C.

Another important property is adhesion. It is important to have adhesion to both substrates that are connected by the BGA. For example one substrate may be semiconductor die covered with a passivation layer (e.g., silicon nitride, polyimide) and a second substrate may be a chip carrier which could be ceramic or polymeric or an FR4 board. Test specimens for adhesion testing can be prepared by stenciling discrete pools of underfill on to PCB board and subsequently placing dies on to pools of underfill. Then the assembly is cured and tested in shear mode. Adhesion testing may be performed after test samples are subjected to highly accelerated stress testing which can involve placing the samples in a 100% relative humidity, 121° C. and a vapor pressure of 2 atmospheres for 20 hours.

Another important property is the viscosity. If the viscosity is too high then, in the case that the underfill is to be applied by capillary action, which is often preferred, the time required for the underfill to penetrate between the two substrates will be unduly long. Viscosity was tested on a Brookfield Model RVTDV-II viscometer equipped with a F96 spindle and using 1, 2.5, 5, 10, 20, and 50 rpm settings.

Underfill materials include reactive components, e.g., the epoxy resin system mentioned above. Underfill materials are generally designed to be heat curable however premature undesired reaction could occur if the underfill were stored at room temperature. In order to prolong the shelf life of underfill material it can be stored at low temperature, e.g., −40° C. However if the reactivity of the underfill is too high the underfill can have an unacceptably short shelf life even when stored at −40° C. One way to quantify the reactivity is to measure time required for gelling to occur when a sample is held at a specified temperature. Gelling occurs when the underfill material starts to cross link. The inventors have tested the gel point by stabilizing the temperature of a hot plate at 150° C., placing a drop of candidate underfill material on a glass slide disposed on the hot plate and periodically pricking the drop of material with a needle until such time as the candidate material stuck to the needle. This time is considered the gel point.

Certain embodiments of the invention provided an increased modulus of elasticity at temperatures above the glass transition temperature, Tg. Having a high modulus of elasticity above Tg helps to protect the solder bumps that are to be protected by the underfill.

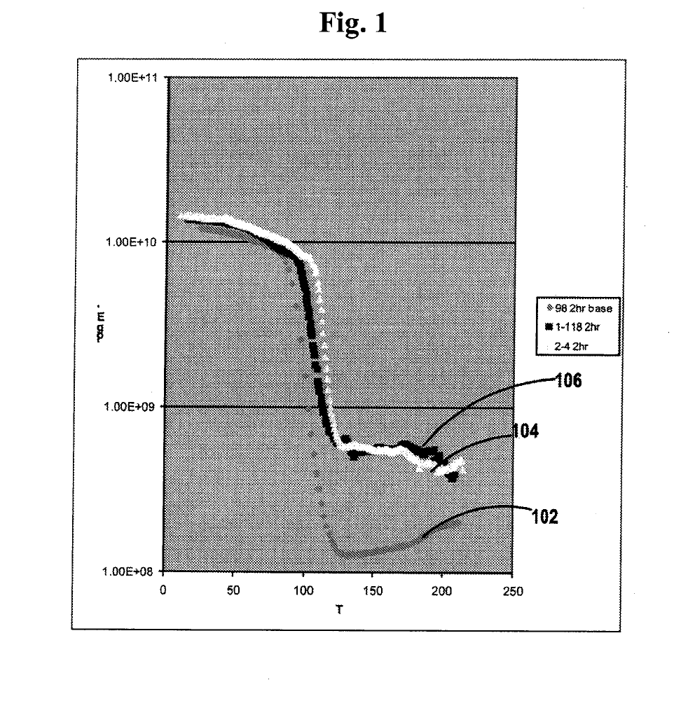

FIG. 1 is a graph including plots 102, 104, 106 of modulus of elasticity versus temperature that were obtained from DMA for the underfill materials of the Comparative Example, 102, Example 1, 104 and Example 2, 106. As is apparent from FIG. 1 the underfill compositions described in Example 1 and Example 2 had greatly superior modulus of elasticity above Tg without much increase in Tg itself (Note that Tg can be identified as the temperature at which the modulus of elasticity drops rapidly.) This superior modulus of elasticity serves to protect solder bumps from mechanical shocks and thermal cycling induced failure.

Table 1 lists some properties of the Comparative Example and Example 1 and Example 2. In Table 1 after pressure cooker test (APCT) (psi) and before pressure cooker test (BPCT) (psi) stands for the shear adhesion in pounds per square inch of the after and before pressure cooker testing. The samples used for shear adhesion testing included a 3 mil (76 micron) stenciled layer of the respective candidate underfill materials bonding a 2 mm by 2 mm nitride passivated silicon die to a FR4 substrate. The pressure cooker testing consisted of placing the samples above the water line in a pressure cooker for 20 hours. The pressure cooker was maintained at 121° C. resulting in a 100% relative humidity (RH), 2 atmosphere pressure test environment.

TABLE 1

| | Comparative | | |
|---|---|---|---|
| PROPERTY | Example | Example 1 | Example 2 |
| BPCT (psi) | 31 | 25 | 25 |
| APCT (psi) | 29 | 22 | 19 |
| Gel pt (min:sec) | 7:30 | 7:00 | 6:55 |
| Viscosity (kCPS) | 52 | N/A | 64 |

Whereas both Example 1 and Example 2 exhibited improved modulus above Tg, the viscosity of Example 1 was deemed too high for use as a capillary type underfill.

### Example 3

In addition to the ingredients in the Comparative Example,

3% of the quaternary amine substituted clay used in Example 1;

10% of the branched siloxane, based on amine equivalents used in Example 2; and

20% of a glycidyl polyhedral oligomeric silsesquioxane (POSS) having the following structural diagram were added.

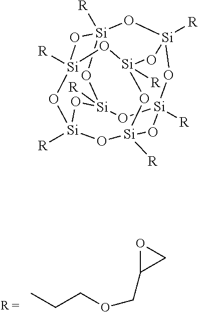

The percentage of glycidyl POSS is given in terms of epoxy equivalents.

### Example 4

The same ingredients in Example 3 were used with changes to the quantities as follows:

2% of quaternary amine substituted clay was used;

5% of the branched siloxane, based on amine equivalents was used; and

10% of the glycidyl POSS, based on epoxy equivalents was used.

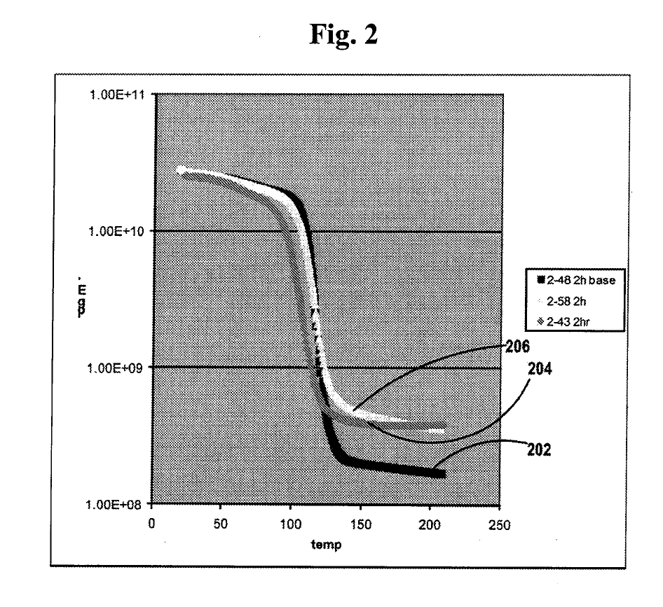

FIG. 2 is a graph including plots of modulus of elasticity versus temperature that were obtained from DMA for the underfill materials of Example 3 and Example 4. In FIG. 2 plot 202 is for the base formulation described in the comparative example, plot 204 is for Example 3 and plot 206 if for Example 4. As shown both Example 3 and Example 4 exhibit superior modulus above Tg compared to the base formulation.

Table 2 below provides additional test data for Example 3 and Example 4.

TABLE 2

| | Comparative | | |
|---|---|---|---|
| PROPERTY | Example | Example 3 | Example 4 |
| BPCT (psi) | 35 | 21 | 23 |
| APCT (psi) | 26 | 18 | 19 |
| Penetration | 5:00 | 4:20 | — |
| (min:sec) | | | |
| Gel pt (min:sec) | 6:45 | 7:00 | 5:30 |
| Viscosity (kCPS) | 49 | 43 | 48.2 |

In addition to the information shown in Table 1, Table 2 includes the Penetration time for Example 3. The penetration time is the time required for the underfill material to be drawn lengthwise through a 50 micron gap 10 mm by 20 mm glass slide and FR4 substrate by capillary action after a line of the underfill material is deposited along an edge of the die at 110 C. FIG. 11 is a schematic illustration of a test set up 1100 for testing the penetration time. A glass slide 1102 is spaced from an FR4 substrate 1104 with a pair of spacers 1106. A drop of capillary underfill 1108 has been dispensed onto the FR4 1104 substrate at one end of the glass slide 1102.

Examples 5 and 6 show the effect of adding epoxide and amine functionalized POSS but without the quaternary amine substituted clay.

### Example 5

In addition to the constituents of the Comparative Example:

30% (based on epoxy equivalents) of the glycidyl POSS used in Example 3 was added.

### Example 6

In addition to the constituents of the Comparative Example:

10% (based on epoxy equivalents) of the glycidyl POSS used in Example 3; and

5% (based on amine equivalents) of an amine functionalized POSS dendrimer, particularly p-aminobenzenethiol POSS of the following form was used:

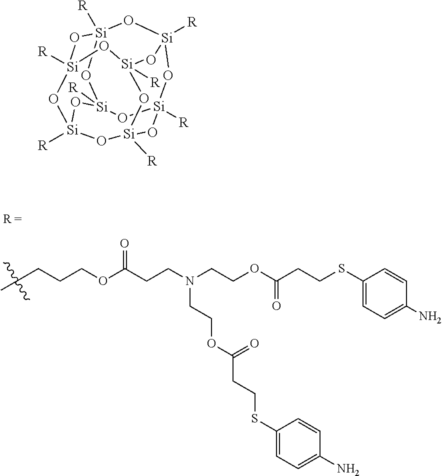

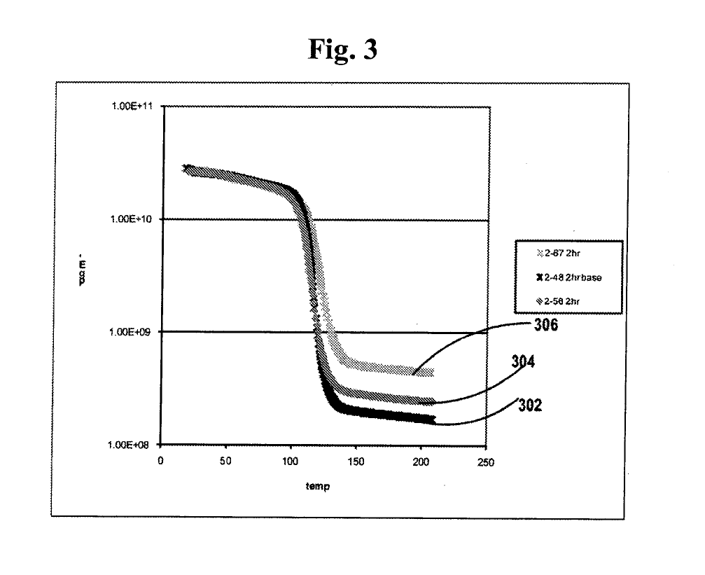

FIG. 3 is a graph including plots 302, 304, 306 of modulus of elasticity versus temperature that were obtained by DMA testing of the comparative example 302, the fifth example 306 and the sixth example 304. As is apparent the fifth example which included the glycidyl POSS without the amine functionalized dendridic POSS was superior in terms of modulus above Tg compared to the sixth example which did include the amine functionalized dendridic POSS. Table 3 below gives additional test data for Example 5 and Example 6.

TABLE 3

| | Comparative | | |
|---|---|---|---|
| PROPERTY | Example | Example 5 | Example 6 |
| BPCT (psi) | 35 | 14 | 27 |
| APCT (psi) | 26 | 10 | 17 |
| Penetration | 5:00 | 12:00 | 3:53 |
| (min:sec) | | | |
| Gel pt (min:sec) | 6:45 | 4:45 | 5:30 |
| Viscosity (kCPS) | 49 | 42.2 | 52 |

### Example 7

In addition to the base formulation described in the Comparative Example, 10% (based on epoxy equivalents) of the glycidyl POSS shown in Example 3 and 0.2% by weight of pyromellitic dianhydride (PMDA) of the following structural formula were added.

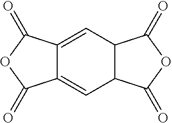

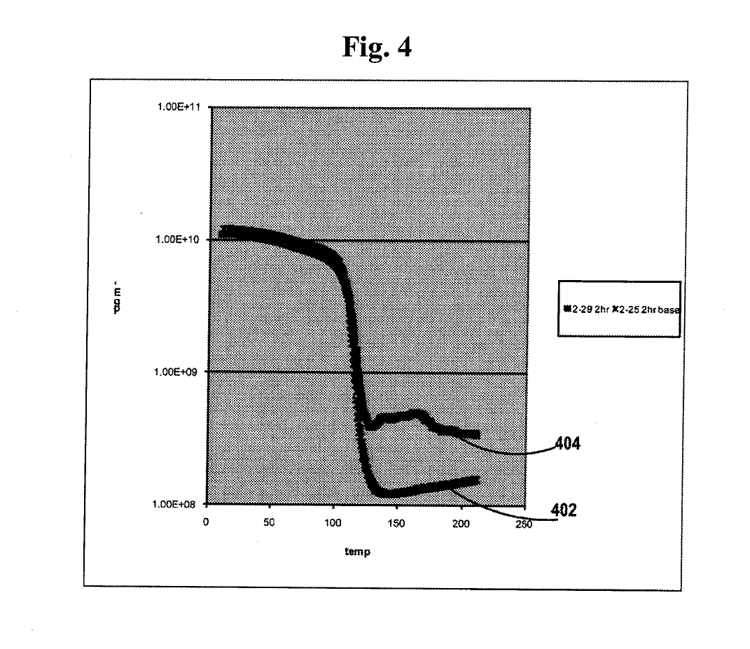

FIG. 4 is a graph including plots 402, 404 of the modulus of elasticity versus temperature that were obtained by DMA testing for the Comparative Example 402 and seventh Example 404. Example 7 exhibited a markedly higher modulus of elasticity above Tg. Table 4 below gives additional test data for Example

TABLE 4

| PROPERTY | Example 7 |
|---|---|
| BPCT (psi) | 33 |
| APCT (psi) | 23 |
| Gel pt (min:sec) | 2:00 |
| Viscosity (kCPS) | 125 |

Examples 8 and 9 are for underfill material with carbon nanotubes.

### Example 8

In addition to the constituents of the Comparative Example, 0.25% by weight of aminopyrene functionalized Multi-Walled Carbon Nano-Tubes (MWCNT) having an average diameter of 15 nanometers and lengths ranging from one to five microns long; and 20% of an epoxy cyclohexyl POSS, based on epoxy equivalents, having the following structural formula were added. The CNTs were obtained from NanoLab in Newton, Mass., catalog #PD30L1-5-NH₂

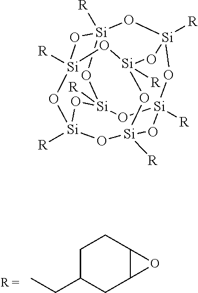

### Example 9

In addition to the constituents of the Comparative Example, 0.25% by wt. of Single Walled Carbon Nanotubes (SWCNT) having an average diameter of 15 nanometers and an average length of 20 microns; and 10% of the glycidyl POSS, based on epoxy equivalents used in Example 3 were added. The CNTs were obtained from NanoLab in Newton, Mass., catalog #D1.5L1-5-NH₂

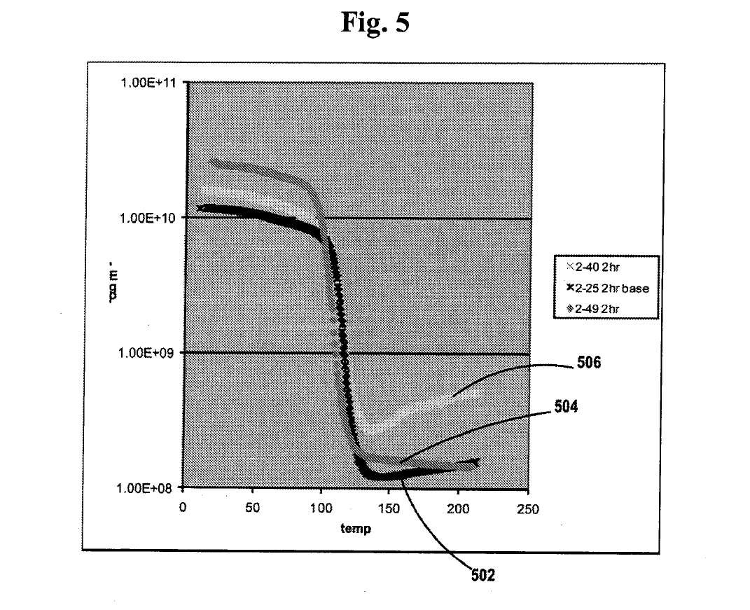

FIG. 5 is a graph including plots 502, 504, 506 of modulus of elasticity versus temperature that were obtained by DMA testing of the comparative example 502, the eighth example 504 and the ninth example 506. As is apparent the ninth example which included the glycidyl POSS and the SWCNT exhibited a markedly increased modulus above Tg. The modulus below Tg is also increase in Example 9. Table 5 below gives additional test data for Example 8 and Example 9.

TABLE 5

| | Comparative | | |
|---|---|---|---|
| PROPERTY | Example | Example 8 | Example 9 |
| BPCT (psi) | 31 | 27 | 26 |
| APCT (psi) | 28 | 25 | 25 |
| Gel pt (min:sec) | 6:15 | 5:45 | 4:40 |
| Viscosity (kCPS) | 57 | N/A | 181 |

### Example 10

In addition to the constituents of the Comparative Example, 5% (based on epoxy equivalents) of the tris(glycidoxypropyldimethylsiloxy)phenylsilane, used in Example 2, 10% (based on epoxy equivalents) of a Triglycidyl Cyclohexyl POSS of the following functional formula:

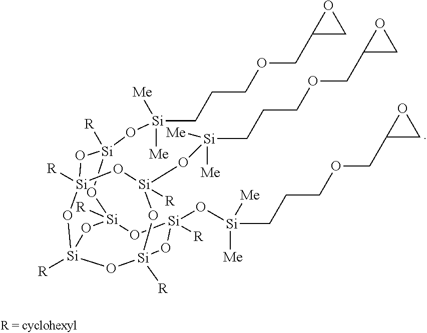

And 0.5% of the quaternary amine substituted clay used in Example 1 were used.

### Example 11

In addition to the constituents of the Comparative Example,

13% by wt. of Zinc Oxide,

0.25% by wt. of PMDA, and

5% (based on epoxy equivalents) of the Triglycidyl Cyclohexyl POSS used in Example 10 were added.

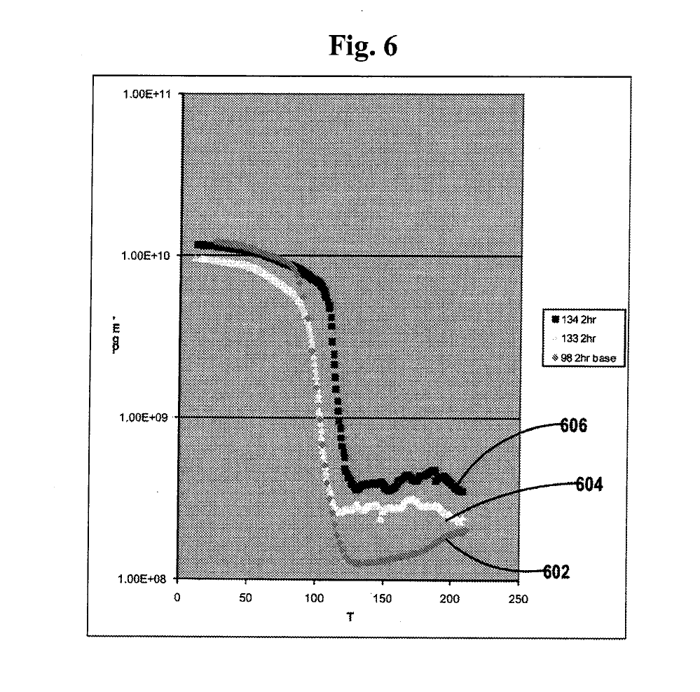

FIG. 6 is a graph including plots 602, 604, 606 of modulus of elasticity versus temperature that were obtained by DMTA testing of the comparative example 602, the tenth example 604 and the eleventh example 606. Table 6 below gives additional test data for Example 10 and Example 11.

TABLE 6

| | Comparative | | |
|---|---|---|---|
| PROPERTY | Example | Example 10 | Example 11 |
| BPCT (psi) | 31 | 26 | 22 |
| APCT (psi) | 29 | 23 | 19 |
| Gel pt (min:sec) | 7:30 | 5:10 | 1:10 |
| Viscosity (kCPS) | 52 | 75.6 | N/A |

Example 11 has significantly higher modulus of elasticity above Tg relative to the Comparative Example, but the modulus is undesirably high for an application by capillary action. Example 10 has a higher modulus above Tg and a Viscosity that is low enough for capillary application.

### Example 12

In addition to the constituents of the comparative example,

2% wt of number 8650 epoxy siloxane made by Dow Corning of Midland Mich.; and

2.5% by wt. of the quaternary amine substituted clay used in Example 1 were added.

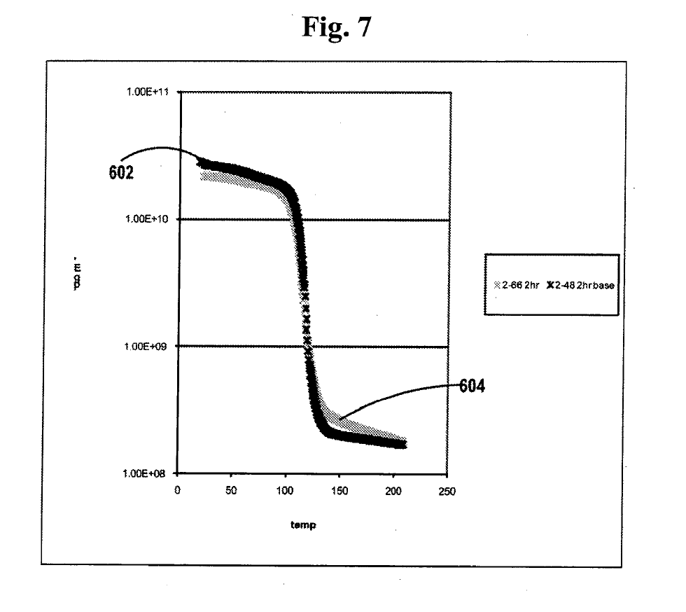

FIG. 7 is a graph including plots 702, 704 of modulus of elasticity versus temperature that were obtained by DMA testing of the comparative example 702, the twelfth example 604. Table 7 below gives additional test data for the twelfth example.

TABLE 7

| | Comparative | |
|---|---|---|
| PROPERTY | Example | Example 12 |
| BPCT (psi) | 35 | 28 |
| APCT (psi) | 26 | 20 |
| Penetration (min:sec) | 5:00 | 5:58 |
| Gel pt (min:sec) | 6:45 | 6:30 |
| Viscosity (kCPS) | 48 | 37.2 |

### Example 13

In addition to the constituents of the base formulation;

40% (based on equivalent epoxy units) of the glycidyl POSS used in Example 3 were added.

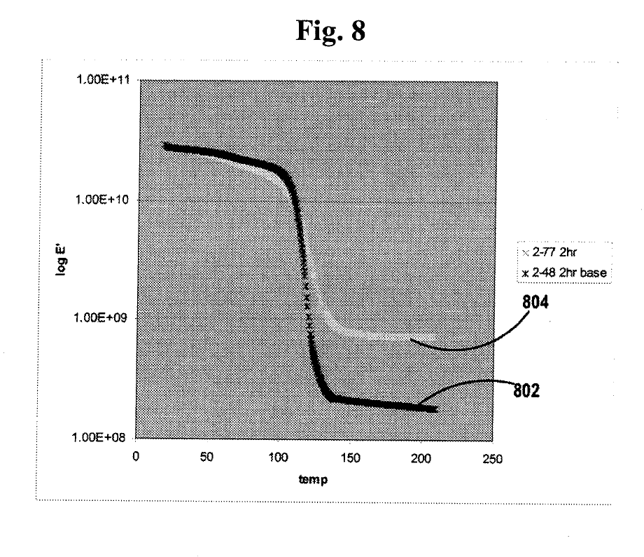

FIG. 8 is a graph including plots 802, 804 of modulus versus temperature that were obtained through DMA testing of a comparative example 802 and Example 12, 804. As shown in the graph the glycidyl POSS markedly improves the modulus above Tg without changing the Tg Usually when E′ is increased Tg also goes up but not in our case). The modulus is nearly 1.0 GigaPascals. Table 8 gives additional information for the Comparative Example and Example 13.

TABLE 8

| | Comparative | |
|---|---|---|
| PROPERTY | Example | Example 13 |
| BPCT (psi) | 35 | 15 |
| APCT (psi) | 26 | 13 |
| Penetration (min:sec) | 5:00 | 13:77 |
| Gel pt (min:sec) | 6:45 | 4:15 |
| Viscosity (kCPS) | 48 | 38 |

### Example 14

In addition to the constituents of the Comparative Example;

0.25% amino pyrene functionalized bamboo CNTs were added.

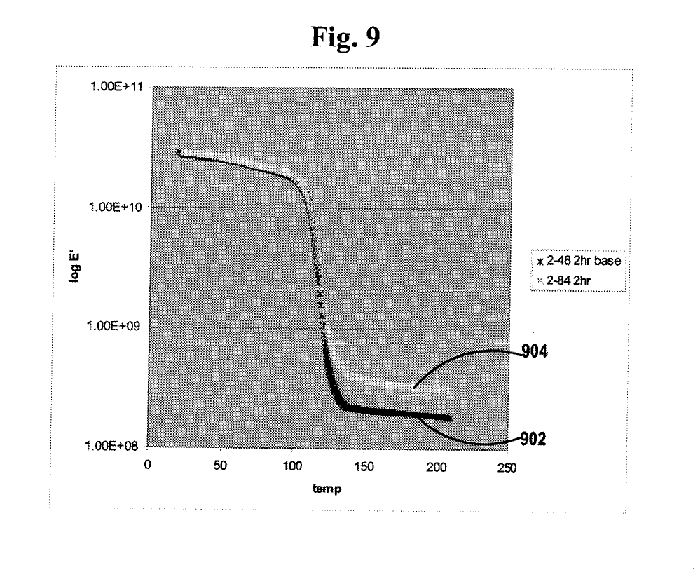

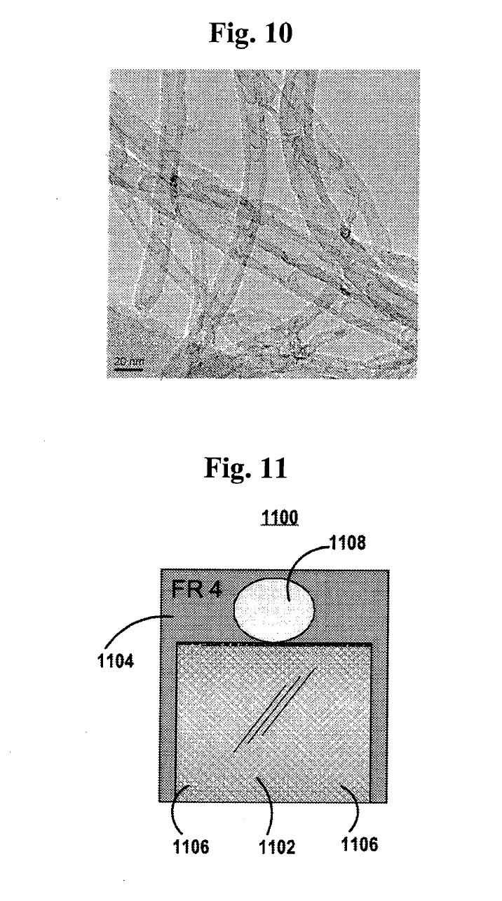

FIG. 10 is an TEM image of bamboo CNTs. Bamboo CNTs are manufactured by NanoLab, Inc. Newton, Mass. under the catalog #BPD30L1-5-NH₂. These are known as “bamboo” because the central hollow space is intermittently blocked by a carbon lattice formation. These bamboo CNTs had an average length of less than one micron and an average diameter of 15 nm FIG. 9 is a graph including plots 902, 904 of modulus versus temperature for a Comparative Example 902 and Example 14 904. As shown the addition of amino pyrene functionalized bamboo CNTs leads to an increase of modulus above Tg. Table 9 gives additional test data for the Comparative Example and Example 14.

TABLE 9

| | Comparative | |
|---|---|---|
| PROPERTY | Example | Example 14 |
| BPCT (psi) | 35 | 22 |
| APCT (psi) | 26 | 15 |
| Penetration (min:sec) | 5:00 | N/A |
| Gel pt (min:sec) | 6:45 | 4:20 |
| Viscosity (kCPS) | 48 | N/A |

### Example 15

Underfill compositions shown in Table 10 were prepared in the same manner as mentioned above.

With regard to the obtained samples, DMA and shear adhesion were measured as follows and the results are shown in Table 11 below.
(1) Modulus of elasticity and Tg (by DMA)
   Device: EXSTAR DMS6100 manufactured by SII NanoTechnology Inc.
   Temperature raising rate: 3° C./min
   Temperature range measured: 24 to 235° C.
   Frequency: 1 Hz
   Deformation mode: three-point bending
   Sample size: 20×10×2 mm
   Curing conditions: Phenol type curing agent: 150° C.×1 Hr (Aromatic amine type curing agent: 165° C.×2 Hr)
(2) Tg (by TMA)
   Device: TMA4000S manufactured by MAC Science Co., Ltd.
   Temperature raising rate: 5° C./min
   Temperature range measured: 20 to 230° C.
   Measurement mode: compression load
   Sample size: Cylindrical shape with a diameter of 8 mm×20 mm length
   Curing conditions: Phenol type curing agent: 150° C.×1 Hr (Aromatic amine type curing agent: 165° C.×2 Hr)
(3) Shear strength
   Device: Bond Tester Series 4000 manufactured by ARCTEC
   Object to be printed:
   Printing method: Circle with a thickness of 125 μm and a diameter of 2.7 mm
   Chip size: 2 mm square
   Passivation: SiN
   Curing conditions: Phenol type curing agent: 150° C.×1 Hr (Aromatic amine type curing agent: 165° C.×2 Hr)
   Head Speed: 200.0 μm/s
(4) PCT
   Curing conditions: Phenol type curing agent: 150° C.×1 Hr (Aromatic amine type curing agent: 165° C.×2 Hr)
   Temperature: 121° C.
   Pressure: 2 atm.
   Vapor pressure: saturated
   Time: 20 hours

TABLE 10

| | Sample No. | | | | | | | | |
|---|---|---|---|---|---|---|---|---|---|
| Composition | 1 | 2 | 3 | 4 | 5 | 6 | 7 | 8 | 9 |
| Bisphenol F type epoxy resin: YDF8170 | 66.49 | 65.51 | 61.57 | 59.60 | 56.64 | 46.81 | 36.97 | 24.17 | 0.56 |
| (available from Tohto Kasei Co., Ltd.) | | | | | | | | | |
| Glycidyl POSS ® Cage Mixture: EP0409 | 0.00 | 1.00 | 4.99 | 6.99 | 9.98 | 19.96 | 29.94 | 42.91 | 66.86 |
| (available from Hybrid Plastics) | | | | | | | | | |
| Aromatic amine type curing agent: | 32.15 | 32.14 | 32.08 | 32.06 | 32.02 | 31.88 | 31.74 | 31.56 | 31.22 |
| KAYAHARD AA (available from Nippon | | | | | | | | | |
| Kayaku Co., Ltd.) | | | | | | | | | |
| 3-Glycidoxypropyltrimethoxysilane (silane | 1.35 | 1.35 | 1.35 | 1.35 | 1.35 | 1.35 | 1.35 | 1.35 | 1.35 |
| coupling agent): KBM403 (available from | | | | | | | | | |
| Shin-Etsu Chemical Co., Ltd.) | | | | | | | | | |
| Total | 100.00 | 100.00 | 100.00 | 100.00 | 100.00 | 100.00 | 100.00 | 100.00 | 100.00 |
| Amount of “POSS/Composition” (%) | 0 | 1 | 5 | 7 | 10 | 20 | 30 | 43 | 67 |
| Remarks | Compara- | Compara- | Present | Present | Present | Present | Present | Compara- | Compara- |
| | tive | tive | invention | invention | invention | invention | invention | tive | tive |

TABLE 11

| Sample No. | 1 | 2 | 3 | 4 | 5 | 6 | 7 | 8 | 9 |
|---|---|---|---|---|---|---|---|---|---|
| Amount of “POSS/- | 0 | 1 | 5 | 7 | 10 | 20 | 30 | 43 | 69 |
| Composition” (%) | | | | | | | | | |
| E1 (at 35° C.) | 3.48 × 10⁹ | 3.57 × 10⁹ | 3.52 × 10⁹ | 3.44 × 10⁹ | 3.48 × 10⁹ | 3.59 × 10⁹ | 3.36 × 10⁹ | 3.62 × 10⁹ | 2.71 × 10⁹ |
| E2 (at 150° C.) | 2.02 × 10⁷ | 2.10 × 10⁷ | 2.26 × 10⁷ | 2.38 × 10⁷ | 2.30 × 10⁷ | 3.59 × 10⁷ | 5.13 × 10⁷ | 8.53 × 10⁷ | 2.60 × 10⁸ |
| Tg (DMA) tan δ peak | 114 | 114 | 113 | 113 | 113 | 112 | 114 | 111 | 89 |
| Tg (TMA) compression | 104 | 101 | 101 | 102 | 102 | 107 | 101 | 98 | 78 |
| Shear (Init.) | 35 | 36 | 35 | 35 | 34 | 36 | 31 | 26 | 22 |
| Shear (PCT) | 30 | 30 | 30 | 30 | 31 | 29 | 27 | 23 | 19 |
| Remarks | Compara- | Compara- | Present | Present | Present | Present | Present | Compara- | Compara- |
| | tive | tive | invention | invention | invention | invention | invention | tive | tive |

Each of the compositions was prepared as follows:
i) Epoxy based polyhedral oligomeric silsesquioxane (EPO409) and bisphenol F (YDF8170) were weighed and charged in an ointment apparatus No. 10, and the mixture was well mixed by using a hybrid mixer with a revolution of 400 rpm and a rotation of 1200 rpm for 1 minute.
ii) Then, to the mixture were added a polyaromatic amine (KAYAHARD AA) and a coupling agent (KBM403) with predetermined amounts, and the resulting mixture was well mixed by using a hybrid mixer with a revolution of 400 rpm and a rotation of 1200 rpm for 2 minutes.
iii) The resulting mixture was allowed to stand in vacuum for 15 minutes to carry out defoaming.

As can be seen from the results shown in Table 11, when an amount of the polyhedral oligomeric silsesquioxane is between 5% by weight and 30% by weight, good results can be obtained.

### Example 16

Underfill compositions which contain inorganic filler shown in Table 12 were prepared in the same manner as in Reference example 1.

With regard to the obtained samples, DMA and shear adhesion were measured in the same manner as in Examples 1 and 2 mentioned above and the results are shown in Table 13 below.

TABLE 12

| | Sample No. | | | | | | | | |
|---|---|---|---|---|---|---|---|---|---|
| Composition | 10 | 11 | 12 | 13 | 14 | 15 | 16 | 17 | 18 |
| Silica: SOE5 (available from Admatechs.) | 63.38 | 63.38 | 63.38 | 63.38 | 63.38 | 63.38 | 63.38 | 63.38 | 63.38 |
| Bisphenol F type epoxy resin: YDF8170 | 24.35 | 23.99 | 22.55 | 21.83 | 20.74 | 17.14 | 13.54 | 8.85 | 0.21 |
| (available from Tohto Kasei Co., Ltd.) | | | | | | | | | |
| Glycidyl POSS ® Cage Mixture: EP0409 | 0.00 | 0.37 | 1.83 | 2.56 | 3.65 | 7.31 | 10.96 | 15.71 | 24.49 |
| (available from Hybrid Plastics) | | | | | | | | | |
| Aromatic amine type curing agent: | 11.77 | 11.77 | 11.75 | 11.74 | 11.73 | 11.67 | 11.62 | 11.56 | 11.43 |
| KAYAHARD AA (available from Nippon | | | | | | | | | |
| Kayaku Co., Ltd.) | | | | | | | | | |
| 3-Glycidoxypropyltrimethoxysilane | 0.50 | 0.50 | 0.50 | 0.50 | 0.50 | 0.50 | 0.50 | 0.50 | 0.50 |
| (silane coupling agent): KBM403 | | | | | | | | | |
| (available from Shin-Etsu Chemical Co., | | | | | | | | | |
| Ltd.) | | | | | | | | | |
| Total | 100.00 | 100.00 | 100.00 | 100.00 | 100.00 | 100.00 | 100.00 | 100.00 | 100.00 |
| Amount of “POSS/Composition” (%) | 0 | 1 | 5 | 7 | 10 | 20 | 30 | 43 | 67 |
| Remarks | Compara- | Compara- | Present | Present | Present | Present | Present | Compara- | Compara- |
| | tive | tive | invention | invention | invention | invention | invention | tive | tive |

TABLE 13

| Sample No. | 10 | 11 | 12 | 13 | 14 | 15 | 16 | 17 | 18 |
|---|---|---|---|---|---|---|---|---|---|
| Amount of “POSS/- | 0 | 1 | 5 | 7 | 10 | 20 | 30 | 43 | 69 |
| Composition” (%) | | | | | | | | | |
| E1 (at 35° C.) | 9.73 × 10⁹ | 9.63 × 10⁹ | 9.49 × 10⁹ | 8.93 × 10⁹ | 9.04 × 10⁹ | 9.49 × 10⁹ | 8.40 × 10⁹ | 9.05 × 10⁹ | 6.79 × 10⁹ |
| E2 (at 150° C.) | 9.72 × 10⁷ | 1.11 × 10⁸ | 1.26 × 10⁸ | 1.33 × 10⁸ | 1.34 × 10⁸ | 2.12 × 10⁸ | 2.97 × 10⁸ | 4.86 × 10⁸ | 1.53 × 10⁹ |
| Tg (DMA) tan δ peak | 113 | 113 | 109 | 110 | 112 | 112 | 106 | 109 | 83 |
| Tg (TMA) compression | 102 | 103 | 97 | 97 | 101 | 99 | 94 | 93 | 72 |
| Shear (Init.) | 37 | 36 | 34 | 35 | 35 | 32 | 31 | 27 | 22 |
| Shear (PCT) | 30 | 29 | 30 | 29 | 30 | 29 | 25 | 22 | 18 |
| Remarks | Compara- | Compara- | Present | Present | Present | Present | Present | Compara- | Compara- |
| | tive | tive | invention | invention | invention | invention | invention | tive | tive |

As can be seen from the results shown in Table 13, when an amount of the polyhedral oligomeric silsesquioxane is between 5% by weight and 30% by weight, good results can be obtained.

### Example 17

Underfill compositions which contain inorganic filler shown in Table 14 were prepared in the same manner as in Reference example 1.

With regard to the obtained samples, DMA and shear adhesion were measured in the same manner as in Examples 1 and 2 mentioned above and the results are shown in Table 15 below.

TABLE 14

| | Sample No. | | | | | | | | |
|---|---|---|---|---|---|---|---|---|---|
| Composition | 28 | 29 | 30 | 31 | 32 | 33 | 34 | 35 | 36 |
| Silica: SOE5 (available from Admatechs.) | 63.38 | 63.38 | 63.38 | 63.38 | 63.38 | 63.38 | 63.38 | 63.38 | 63.38 |
| Bisphenol F type epoxy resin: YDF8170 | 18.58 | 18.30 | 17.20 | 16.65 | 15.83 | 13.08 | 10.33 | 6.75 | 0.15 |
| (available from Tohto Kasei Co., Ltd.) | | | | | | | | | |
| Glycidyl POSS ® Cage Mixture: EP0409 | 0.00 | 0.37 | 1.83 | 2.56 | 3.65 | 7.31 | 10.96 | 15.71 | 24.49 |
| (available from Hybrid Plastics) | | | | | | | | | |
| Polypropylene glycol diglycidyl ether: PG | 6.87 | 6.77 | 6.36 | 6.16 | 5.85 | 4.84 | 3.82 | 2.50 | 0.06 |
| 207GS (available from Tohto Kasei Co., | | | | | | | | | |
| Ltd.) | | | | | | | | | |
| Aromatic amine type curing agent: | 10.67 | 10.68 | 10.73 | 10.75 | 10.79 | 10.90 | 11.01 | 11.16 | 11.43 |
| KAYAHARD AA (available from Nippon | | | | | | | | | |
| Kayaku Co., Ltd.) | | | | | | | | | |
| 3-Glycidoxypropyltrimethoxysilane (silane | 0.50 | 0.50 | 0.50 | 0.50 | 0.50 | 0.50 | 0.50 | 0.50 | 0.50 |
| coupling agent): KBM403 (available from | | | | | | | | | |
| Shin-Etsu Chemical Co., Ltd.) | | | | | | | | | |
| Total | 100.00 | 100.00 | 100.00 | 100.00 | 100.00 | 100.00 | 100.00 | 100.00 | 100.00 |
| Amount of “POSS/Composition” (%) | 0 | 1 | 5 | 7 | 10 | 20 | 30 | 43 | 67 |
| Remarks | Compara- | Compara- | Present | Present | Present | Present | Present | Compara- | Compara- |
| | tive | tive | invention | invention | invention | invention | invention | tive | tive |

TABLE 15

| Sample No. | 28 | 29 | 30 | 31 | 32 | 33 | 34 | 35 | 36 |
|---|---|---|---|---|---|---|---|---|---|
| Amount of “POSS/- | 0 | 1 | 5 | 7 | 10 | 20 | 30 | 43 | 69 |
| Composition” (%) | | | | | | | | | |
| E1 (at 35° C.) | 9.92 × 10⁹ | 9.72 × 10⁹ | 9.87 × 10⁹ | 9.47 × 10⁹ | 9.13 × 10⁹ | 9.68 × 10⁹ | 8.32 × 10⁹ | 9.68 × 10⁹ | 7.06 × 10⁹ |
| E2 (at 150° C.) | 1.04 × 10⁸ | 1.17 × 10⁸ | 1.32 × 10⁸ | 1.44 × 10⁸ | 1.42 × 10⁸ | 2.27 × 10⁸ | 3.24 × 10⁸ | 5.39 × 10⁸ | 1.59 × 10⁹ |
| Tg (DMA) tan δ peak | 92 | 89 | 88 | 92 | 91 | 90 | 88 | 87 | 72 |
| Tg (TMA) compression | 81 | 79 | 77 | 79 | 77 | 78 | 79 | 76 | 64 |
| Shear (Init.) | 35 | 35 | 34 | 34 | 33 | 35 | 29 | 26 | 22 |
| Shear (PCT) | 27 | 26 | 26 | 27 | 28 | 25 | 25 | 21 | 16 |
| Remarks | Compara- | Compara- | Present | Present | Present | Present | Present | Compara- | Compara- |
| | tive | tive | invention | invention | invention | invention | invention | tive | tive |

As can be seen from the results shown in Table 15 when an amount of the polyhedral oligomeric silsesquioxane is between 5% by weight and 30% by weight, good results can be obtained.

### Example 18

Underfill compositions which do not contain inorganic filler shown in Table 16 were prepared in the same manner as in Reference example 1.

With regard to the obtained samples, DMA and shear adhesion were measured in the same manner as in Examples 1 and 2 mentioned above and the results are shown in Table 17 below.

TABLE 16

| | Sample No. | | | | | |
|---|---|---|---|---|---|---|
| Composition | 37 | 38 | 39 | 40 | 41 | 42 |
| Bisphenol F type epoxy resin: YDF8170 | 55.29 | 50.46 | 45.64 | 35.99 | 26.35 | 7.04 |
| (available from Tohto Kasei Co., Ltd.) | | | | | | |
| Glycidyl POSS ® Cage Mixture: EP0409 | 0.00 | 4.91 | 9.83 | 19.66 | 29.49 | 49.15 |
| (available from Hybrid Plastics) | | | | | | |
| Liquid state phenol novolac resin: MEH8005 | 41.26 | 41.18 | 41.09 | 40.90 | 40.71 | 40.36 |
| (available from Meiwa Plastic Industries, Ltd.) | | | | | | |
| 3-Glycidoxypropyltrimethoxysilane (silane | 0.67 | 0.67 | 0.67 | 0.67 | 0.67 | 0.68 |
| coupling agent): KBM403 (available from Shin- | | | | | | |
| Etsu Chemical Co., Ltd.) | | | | | | |
| Imidazole: 2MZ (available from Shikoku | 2.77 | 2.77 | 2.77 | 2.77 | 2.77 | 2.77 |
| Chemicals Corporation) | | | | | | |
| Total | 100.00 | 100.00 | 100.00 | 100.00 | 100.00 | 100.00 |
| Amount of “POSS/Composition” (%) | 0 | 5 | 10 | 20 | 30 | 50 |
| Remarks | Compara- | Present | Present | Present | Present | Compara- |
| | tive | invention | invention | invention | invention | tive |

TABLE 17

| Sample No. | 37 | 38 | 39 | 40 | 41 | 42 |
|---|---|---|---|---|---|---|
| Amount of “POSS/- | 0 | 5 | 10 | 20 | 30 | 50 |
| Composition” (%) | | | | | | |
| E1 (at 35° C.) | 3.12 × 10⁹ | 2.76 × 10⁹ | 3.19 × 10⁹ | 2.72 × 10⁹ | 1.60 × 10⁹ | 1.13 × 10⁸ |
| E2 (at 150° C.) | 3.66 × 10⁶ | 6.84 × 10⁶ | 1.12 × 10⁷ | 2.00 × 10⁷ | 3.20 × 10⁷ | 5.57 × 10⁷ |
| Tg (DMA) tanδ peak | 75 | 75 | 72 | 66 | 57 | 35 |
| Tg (TMA) compression | 58 | 58 | 59 | 54 | 47 | 36 |
| Shear (Init.) | 33 | 33 | 32 | 32 | 31 | 30 |
| Shear (PCT) | 27 | 27 | 27 | 28 | 25 | 16 |
| Remarks | Compara- | Present | Present | Present | Present | Compara- |
| | tive | invention | invention | invention | invention | tive |

As can be seen from the results shown in Table 17, when an amount of the polyhedral oligomeric silsesquioxane is between 5% by weight and 30% by weight, good results can be obtained.

### Example 19

Underfill compositions which contain inorganic filler shown in Table 18 were prepared in the same manner as in Reference example 1.

With regard to the obtained samples, DMA and shear adhesion were measured in the same manner as in Examples 1 and 2 mentioned above and the results are shown in Table 19 below.

TABLE 18

| | Sample No. | | | | | |
|---|---|---|---|---|---|---|
| Composition | 43 | 44 | 45 | 46 | 47 | 48 |
| Silica: SOE5 (available from Admatechs.) | 56.04 | 54.70 | 54.70 | 54.70 | 54.70 | 54.70 |
| Bisphenol F type epoxy resin: YDF8170 | 24.31 | 21.65 | 19.58 | 15.45 | 11.31 | 3.02 |
| (available from Tohto Kasei Co., Ltd.) | | | | | | |
| Glycidyl POSS ® Cage Mixture: EP0409 | 0.00 | 2.11 | 4.22 | 8.44 | 12.65 | 21.09 |
| (available from Hybrid Plastics) | | | | | | |
| Liquid state phenol novolac resin: | 18.14 | 17.67 | 17.63 | 17.55 | 17.47 | 17.32 |
| MEH8005 (available from Meiwa Plastic | | | | | | |
| Industries, Ltd.) | | | | | | |
| 3-Glycidoxypropyltrimethoxysilane (silane | 0.30 | 0.29 | 0.29 | 0.29 | 0.29 | 0.29 |
| coupling agent): KBM403 (available from | | | | | | |
| Shin-Etsu Chemical Co., Ltd.) | | | | | | |
| Imidazole: 2MZ (available from Shikoku | 1.22 | 3.57 | 3.57 | 3.57 | 3.57 | 3.57 |
| Chemicals Corporation) | | | | | | |
| Total | 100.00 | 100.00 | 100.00 | 100.00 | 100.00 | 100.00 |
| Amount of “POSS/Composition” (%) | 0 | 5 | 10 | 20 | 30 | 50 |
| Remarks | Compara- | Present | Present | Present | Present | Compara- |
| | tive | invention | invention | invention | invention | tive |

TABLE 19

| Sample No. | 43 | 44 | 45 | 46 | 47 | 48 |
|---|---|---|---|---|---|---|
| Amount of “POSS/- | 0 | 5 | 10 | 20 | 30 | 50 |
| Composition” (%) | | | | | | |
| E1 (at 35° C.) | 8.79 × 10⁹ | 8.57 × 10⁹ | 8.33 × 10⁹ | 8.41 × 10⁹ | 7.85 × 10⁹ | 2.97 × 10⁹ |
| E2 (at 150° C.) | 5.04 × 10⁷ | 6.82 × 10⁷ | 8.47 × 10⁷ | 1.56 × 10⁸ | 2.12 × 10⁸ | 3.40 × 10⁸ |
| Tg (DMA) tan δ peak | 77 | 78 | 76 | 74 | 70 | 49 |
| Tg (TMA) compression | 63 | 65 | 66 | 62 | 59 | 52 |
| Shear (Init.) | 30 | 33 | 30 | 33 | 32 | 23 |
| Shear (PCT) | 29 | 27 | 28 | 28 | 25 | 16 |
| Remarks | Compara- | Present | Present | Present | Present | Compara- |
| | tive | invention | invention | invention | invention | tive |

As can be seen from the results shown in Table 19, when an amount of the polyhedral oligomeric silsesquioxane is between 5% by weight and 30% by weight, good results can be obtained.

### UTILIZABILITY IN INDUSTRY

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An underfill composition comprising the following components (A)-(C):
(A) an epoxy resin,
(B) a curing agent, and
(C) a polyhedral oligomeric silsesquioxane having at least one epoxy group,
wherein amounts in weight of the above components (A), (B) and (C) satisfy the following relationship:
0.05≦(C)/((A)+(B)+(C))≦0.3.

2. An underfill composition according to claim 1, wherein the composition further comprises (D) an inorganic filler.

3. The underfill composition according to claim 1, wherein the component (D) is contained in the composition in an amount of 30% by weight to 70% by weight.

4. The underfill composition according to claim 1, wherein the underfill composition after hardening has a Tg within the range of 55° C. to 115° C. by DMA.

5. The underfill composition according to claim 1, wherein the curing agent comprises an imidazole derivative, an aromatic amine or a carboxylic acid anhydride.

6. The underfill composition according to claim 5, wherein the composition further comprises a Tg modifier.

7. The underfill composition according to claim 6, wherein the Tg modifier comprises a reactive diluent.

8. The underfill composition according to claim 6, wherein the Tg modifier is polypropylene glycol diglycidyl ether.

9. The underfill composition according to claim 1, wherein the curing agent comprises a liquid phenol.

10. The underfill composition according to claim 9, wherein the liquid phenol is an allylic phenol novolak.

11. The underfill composition according to claim 1, wherein the inorganic filler comprises at least one selected from silica, alumina and aluminum nitride.

12. The underfill composition according to claim 1, wherein the composition further comprises at least one selected from the group consisting of a solvent, a flux, a defoamer, a coupling agent, a flame retardant, a curing accelerator, liquid or granular elastomer and a surfactant.

13. An underfill material comprising:
a resin functionalized with at least a first reactive group;
a nano filler material functionalized with at least a second reactive group that is reactive with said first reactive group of said resin.

14. The underfill material according to claim 13 wherein said resin functionalized with at least said first reactive group comprises a siloxane functionalized with a reactive glycidyl group.

15. The underfill material according to claim 14 wherein said siloxane functionalized with said reactive glycidyl group comprises polyhedral oligomeric silsesquioxane functionalized with said glycidyl group.

16. The underfill according to claim 14 wherein said siloxane functionalized with said reactive glycidyl group comprises tris(glycidoxypropyldimethylsiloxy)phenylsilane.

17. The underfill material according to claim 13 wherein said fill material comprises carbon nanotubes.

18. The underfill material according to claim 17 wherein said carbon nanotubes are amine functionalized.

19. The underfill material according to claim 17 wherein said carbon nanotubes are functionalized with aminopyrene.

20. The underfill material according to claim 13 wherein said first reactive group comprises an epoxy group.

21. The underfill material according to claim 17 wherein said carbon nanotubes have an average length of less than 5 microns.

22. The underfill material according to claim 21 wherein said carbon nanotubes are single walled carbon nanotubes.

23. The underfill material according to claim 21 wherein said carbon nanotubes are multi walled carbon nanotubes.

24. The underfill material according to claim 21 wherein said carbon nanotubes are bamboo carbon nanotubes.

25. The underfill material according to claim 18 wherein said carbon nanotubes are single wall carbon nanotubes having average length of less than 5 microns and are functionalized with aminopyrene.

26. The underfill material according to claim 13 further comprising silica and a silane coupling agent.

27. The underfill material according to claim 13 wherein said resin further comprises bisphenol F epoxy.

28. The underfill material according to claim 13 wherein said resin comprises a fluoro silicone defoamer.

29. The underfill material according to claim 13 wherein the underfill has a glass transition temperature within a range of about 90° C. to about 135° C.

30. The underfill material according claim 13 wherein the underfill has a Young's modulus above Tg greater than 0.3 GPa.

31. The underfill material according to claim 13 wherein said filler material comprises a functionalized organo clay.

32. The underfill material according to claim 31 wherein said functionalized organo clay is in the form of platelets having a thickness dimension that is less than 20 nanometers.

33. The underfill material according to claim 31 wherein said inorganic filler functionalized organo clay comprises Montomorillonite functionalized with a quaternary amine.

34. The underfill material according to claim 31 further comprising silica and a silane coupling agent.

35. The underfill material according to claim 34 wherein said resin comprises a polyaromatic amine.

36. The underfill material according to claim 35 wherein said resin further comprises bisphenol F epoxy.

37. The underfill material according to claim 36 wherein said resin further comprises a fluoro silicone defoamer.

38. The underfill material according to claim 13 further comprising a polyhedral oligomeric silsesquioxane.

39. The underfill material according to claim 38 wherein said polyhedral oligomeric silsesquioxane comprises at least one epoxy groups.

40. The underfill material according to claim 39 wherein said polyhedral oligomeric silsesquioxane comprises glycidyl polyhedral oligomeric silsesquioxane.

41. The underfill material according to claim 39 wherein said polyhedral oligomeric silsesquioxane comprises triglycidyl cyclohexyl polyhedral oligomeric silsesquioxane.

42. The underfill material according to claim 39 wherein said polyhedral oligomeric silsesquioxane comprises epoxy cyclohexyl polyhedral oligomeric silsesquioxane.

43. The underfill material according to claim 39 further comprising a branched chain siloxane.

44. The underfill material according to claim 43 wherein said branched chain silioxane is functionalized with a reactive coupling group.

45. The underfill material according to claim 44 wherein said reactive coupling group comprises an epoxide group.

46. An underfill material comprising pyromellitic dianhydride and a metal oxide.

47. The underfill material according to claim 46 wherein said metal oxide is zinc oxide.

48. The underfill material according to claim 47 further comprising a glycidyl polyhedral oligomeric silsesquioxane.

49. The underfill material according to claim 48 further comprising silica and a silane coupling agent.

50. The underfill material according to claim 49 further comprising bisphenol F epoxy.

51. The underfill material according to claim 50 further comprising a fluoro silicone defoamer.

52. An underfill comprising:
an epoxy resin; and
an additive which increase a modulus of elasticity above a glass transition temperature of said epoxy resin without substantially altering the glass transition temperature of said epoxy resin.

53. The underfill according to claim 52 wherein said glass transition temperature is altered by said additive by less than 10° C.

54. The underfill material according to claim 53 wherein said additive comprises glycidyl siloxane.
